(19) United States
(12) Patent Application Publication
(10) Pub. No.: US 2008/0060062 A1
(43) Pub. Date: Mar. 6, 2008

(54) METHODS AND SYSTEMS FOR PREVENTING INFORMATION THEFT

(76) Inventor: Robert B Lord, Mountain View, CA (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 11/469,471

(22) Filed: Aug. 31, 2006

(51) Int. Cl. H04L 9/32

(52) U.S. Cl. 726/5

(57) ABSTRACT

Embodiments of the present invention assist in preventing information theft by automatically blocking a user from interacting with an invalid or insecure site on a network, such as a suspect SSL site the Internet. In particular, information theft may be prevented by determining the validity of a secure destination. Instead of providing a warning, the user is automatically blocked from establishing a connection to that site, or blocks any rendering of the broken site. The user may then realize that they have navigated to an unsecured location and should reconsider their action.

### FIELD

This invention relates generally to security systems and methods.

### BACKGROUND

Presently, consumers utilize the Internet to perform many different tasks that were conventionally done in person. Consumers can utilize the Internet to purchase products, perform personal transaction, and manage funds. During these tasks, consumers may be required to enter sensitive personal information. In order to protect personal information during these transactions, different types of security protocols are utilized such as secure socket layer (SSL). SSL is a network protocol for transmitting private documents via the Internet. SSL uses a cryptographic system that uses two keys to encrypt data—a public key known to everyone and a private or secret key known only to the recipient of the data.

When establishing a connection to an SSL website, the consumer is typically given a warning or popup. However, most consumers ignore these warnings. By ignoring the warnings, the consumer may not realize that a SSL website may be invalid. As a result, many phishing sites employ a broken SSL site (i.e., an SSL site with an expired, revoked, incorrect type, or self signed certificate). As such, the consumer may enter sensitive information into an insecure website.

### BRIEF DESCRIPTION OF THE DRAWINGS

The accompanying drawings, which are incorporated in and constitute a part of this specification, illustrate one embodiment of the invention and together with the description, serve to explain the principles of the invention.

FIG. 1 is a diagram illustrating an exemplary network system consistent with embodiments of the present disclosure.

FIG. 2 is a diagram illustrating an exemplary computing platform consistent with embodiments of the present disclosure.

FIG. 3 is a flow diagram illustrating a method for preventing information theft consistent with embodiments of the present disclosure.

FIG. 4 is a flow diagram illustrating a method of preventing phishing of personal information consistent with embodiments of the present disclosure.

FIGS. 5A and 5B are diagrams illustrating an exemplary application window consistent with embodiments of the present disclosure.

### DESCRIPTION OF THE EMBODIMENTS

To acquire sensitive user information, attackers may utilize invalid secure destinations, such as websites, to induce users to enter sensitive personal information. According to embodiments of the present disclosure, information theft is prevented by determining the validity of a secure destination. Instead of providing a warning, an application, such as a browser, blocks the user from establishing a connection to that site, or blocks any rendering of the broken site. The user is then expected to realize that they have navigated to an unsecured location and should reconsider their action.

According to embodiments, an application receives a request to establish a connection to a secure destination. The application determines a validity of the secure destination. The application then automatically blocks a connection to the secure destination if the destination is invalid. The application may be a web browser in which a user attempts to establish a connection to a SSL website.

Reference will now be made in detail to the exemplary embodiments of the invention, an example of which is illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

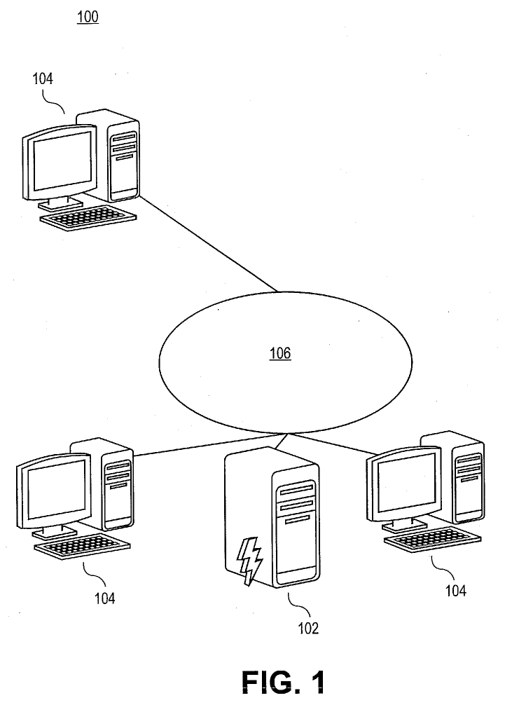

According to embodiments of the present disclosure, information theft is prevented by preventing sensitive information form being transmitted to invalid information. FIG. 1 is a diagram illustrating a network system 100 in which the information theft may be prevented. System 100 may include a server 102 and clients 104. Server 102 and clients 104 internet, the Internet, a wide area network, or a local area network. FIG. 1 shows system 100 including three clients and one server connected via a single network. One skilled in the art will realize that system 100 may include any number of clients and servers connected via multiple networks.

Server 102 may be a computing machine or platform configured to execute a network system through an operating system in conjunction with clients 104. Server 102 may send data to clients 104 and receive data from clients 104. Server 102 may be configured to host secure destinations, such as SSL websites. Server 102 may be implemented with any known server platforms such as those from Intel, Advanced Micro Devices, Hewlett-Packard, etc. One skilled in the art will realize that the above server systems are exemplary and server 102 may be implemented in any known platform.

Clients 104 may be computing machines or platforms configured to execute applications to perform methods for preventing information theft. Clients 104 may implements network application such as web browsers. Clients 104 may be implemented with personal computers, workstations, thin clients, thick clients, or other similar computing platforms. Clients 104 may use operating systems such as Linux, Windows, Macintosh or other available operating systems. One skilled in the art will realize that the implementations of clients 104 are exemplary and clients 104 may be implemented in any type of computer system.

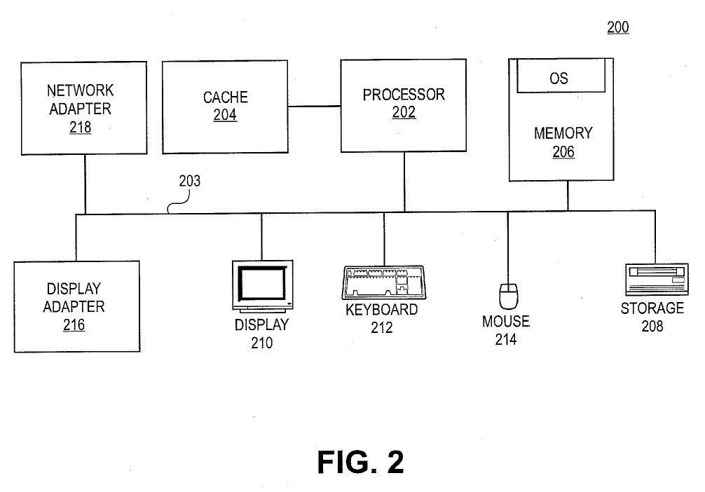

FIG. 2 is a block diagram of an exemplary computing platform 200 capable of performing embodiments of the present disclosure. Computing platform 200 may be utilized as clients 104 and server 102. The methods for preventing information theft may be implemented application may be implemented in computer languages such as PASCAL, C, C++, JAVA, HTML and the like. For example, when a SSL website is being accessed, a web browser, such as Explorer, Firefox, etc., may be executed on computing platform 200. One skilled in the art will realize that the methods for preventing information theft may be implemented in any computer language and any application capable of establishing a network connection.

As shown in FIG. 2, the computing platform 200 may include one or more processors such as the illustrated processor 202 that provide an execution platform for embodiments of the of the present disclosure. Processor 202 may be connected to a cache 204 to serve as a working memory. Commands and data from the processor 202 may be communicated over a communication bus 203.

Computing platform 200 may include a main memory 206, such as a Random Access Memory (RAM), where the operating system and applications implementing the methods described above may be executed during runtime. Main memory 206 may be coupled to communication bus 203.

Computing platform 200 may include one or more secondary memories 208. Secondary memories may be coupled to communications bus 203. The secondary memories 208 may include, for example, a hard disk drive and/or a removable storage drive, representing a floppy diskette drive, a magnetic tape drive, a compact disk drive, and the like, where a copy of a computer program embodiment for applications for preventing information theft may be stored. The secondary memories 208 may read from and/or write to between themselves in a well-known manner.

Computing platform 200 may also include a keyboard 212, a mouse 214, and a display 210 for allowing a user to interface with computing platform 200. Keyboard 212, mouse 214, and display 210 may be coupled to communications bus 203. Computing platform 200 may also include a display adapter 216. Display adapter 216 may be coupled to communication bus 203. Display adapter 216 can interface with the communication bus 203 and the display 210 and can receive display data from the processor 202 and converts the display data into display commands for the display 210.

Computing platform 200 may also include a network adapter 218. Network adapter 218 may be coupled to communication bus 203. Network adapter 218 may allow computing platform 200 to send and receive data via a network, such as network 106.

According to embodiments of the present disclosure, any of the methods for preventing information theft can be embodied on a computer readable storage medium as instruction for causing a computer platform to perform the instructions. The computer readable storage medium may include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software programs of the computer program on a CD-ROM or via Internet download. In a sense, the Internet itself, as an abstract entity, is a computer readable medium. The same is true of computer networks in general.

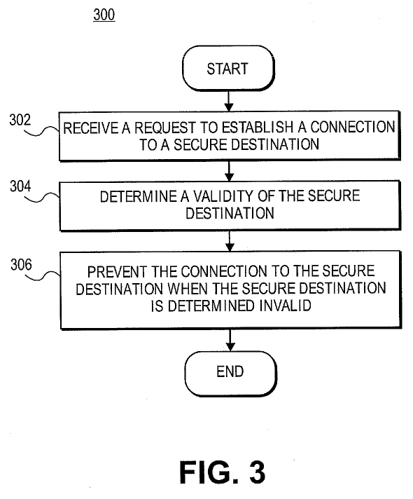

FIG. 3 is a flow diagram illustrating a method 300 for preventing information theft. Method 300 prevents information theft by determining the validity of a secure destination. Method 300 then blocks a connection to the secure destination if the destination is invalid.

Method 300 may be implemented in any type of application for granting access executed on a computer platform. For example, method 300 may be performed by a web browser or website hosting application executed on a computing platform. Method 300 may be performed on any computing platform or computing platform in a network system, such as computer platform 200 and network system 100 described below. One skilled in the art will realize that method 300 may be performed on any computing platform in which access to a system requires entry of access information.

Method 300 begins when an application, such as a web browser or website hosting application, receives a request to establish a connection to a secure destination (stage 302). For example, a web browser may receive a request by a user to establish a connection, such as a secure connection, to a website, such as a SSL website, to enter personal information.

Next, the application determines the validity of the secure destination (stage 304). The validity of the secure destination may be determined by several methods. The validity of the destination may be determined by comparing the intended destination of the access information with the actual destination of the access information. Further, the validity of the secure destination may be determined by comparing the secure destination with known invalid secure destination. Additionally, the validity of the secure destination may be determined by authenticating the secure destination.

Then, the application prevents a connection with the secure destination when the secure destination is determined invalid (stage 306). The connection may be prevented by blocking a connection with the secure destination. Also, the connection may be prevented by preventing transmission of data on the secure destination.

Additionally, the application may send a message to the user indicating that the connection has been prevented. For example, if the application is a browser, a user interface (UI) may be displayed in the browser informing the user that the connection has been prevented. The message may include the address of the secure destination and the reason for preventing the connection.

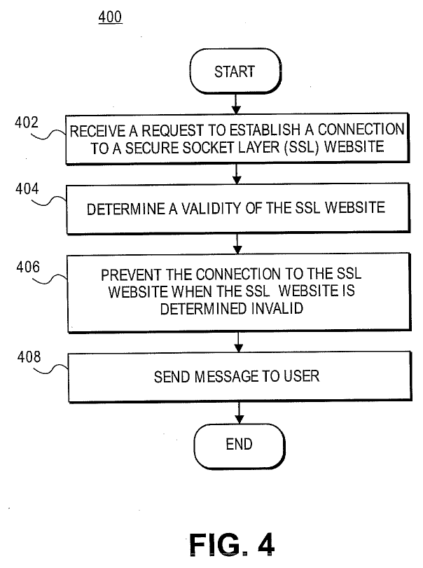

FIG. 4 is a flow diagram illustrating a method 400 for preventing information theft consistent with embodiments of the disclosure. Method 400 prevents information theft by preventing a connection to a SSL website.

Method 400 may be implemented in an application for granting access. For example, method 400 may be performed by a web browser or website hosting application executed on a computing platform. Method 400 may be performed on any computing platform or computing platform in a network system, such as computer platform 200 and network system 100 described below. One skilled in the art will realize that method 400 may be performed on any computing platform in which access to a system requires entry of access information.

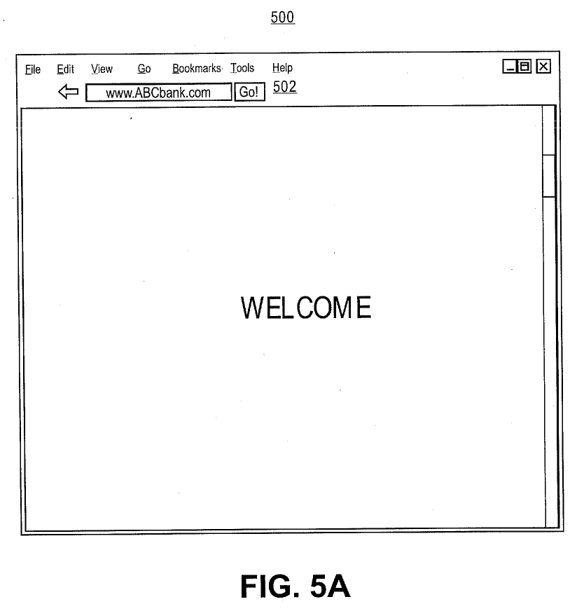

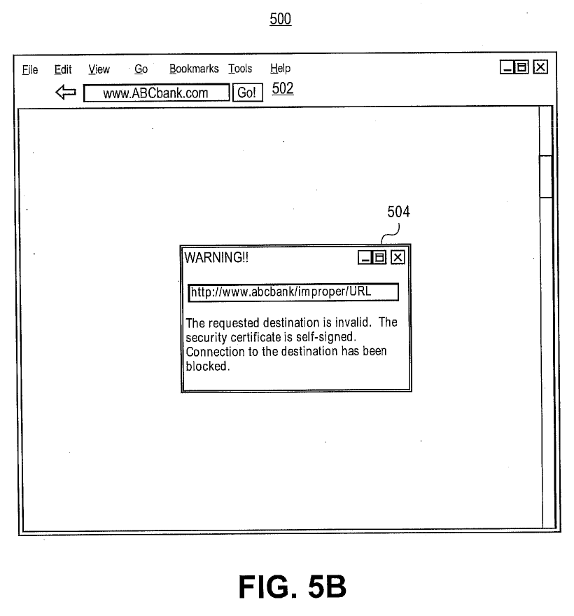

Method 400 begins when a web browser receives a request to establish a connection to a SSL website (stage 402). For example, a user may request access to a banking website to perform a financial transaction. As such, the web browser may be required to establish a secure connection to the website so that the user may transmit sensitive information. FIG. 5A is a diagram illustrating an exemplary browser for establishing a connection to a SSL website. To establish a connection, the user may enter the address of the SSL website, for example www.abcbank.com, in field 502.

Next, the browser determines the validity of the SSL website (stage 404). The browser may validate the SSL website by several methods. The validity of the destination may be determined by comparing the intended SSL website with the actual website with which the user seeks connection.

Further, the validity of the SSL website may be determined by comparing the intended website with known invalid websites. For example, the browser may check the intended website with a list of invalid SSL websites.

Additionally, the validity of the SSL website may be determined by authenticating the website. For example, the browser may authenticate the certificate of the SSL website. The browser may prevent connection to the website if the certificate is expired, revoked, incorrect type, or self-signed. One skilled in the art will realize that any type of known method may be used to authenticate the website.

Then, the browser prevents a connection with SSL website when the website is determined invalid (stage 406). The browser may prevent the connection by blocking a connection with the SSL website. Also, the browser may prevent a connection by preventing the SSL website from rendering.

Additionally, the browser may transmit a message to the user indicating that the connection has been prevented (stage 408). FIG. 5B is a diagram illustrating an exemplary message according to embodiments of the present disclosure. As shown in FIG. 5B, a UI 504 may be displayed in the browser informing the user that the connection has been prevented. As shown in FIG. 5B, UI 504 may include the address of the secure destination and the reason for preventing the connection.

Other embodiments of the present teaching will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of preventing information theft, comprising:
receiving a request to establish a connection to a secure destination;
determining a validity of the secure destination; and
preventing the connection to the secure destination when the secure destination is determined invalid,
wherein determining the validity of the secure destination comprises authenticating security credentials of the secure destination.

2. The method of claim 1, further comprising sending a message when the connection is prevented.

3. The method of claim 1, wherein the secure destination is determined invalid if the security credentials are expired.

4. The method of claim 1, wherein the secure destination is determined invalid if the security credentials are revoked.

5. The method of claim 1, wherein the secure destination is determined invalid if the security credentials are an incorrect type.

6. The method of claim 1, wherein the secure destination is determined invalid if the security credentials do not originate from a known and trusted issuer are self-signed.

7. The method of claim 1, wherein the secure destination is determined invalid if the security credentials are self-signed.

8. The method of claim 1, wherein preventing the connection to the secure destination comprises blocking connection to the secure destination.

9. The method of claim 1, wherein preventing the connection to the secure destination comprises disabling rendering of the secure destination.

10. An apparatus comprising of means for performing the method of claim 1.

11. A computer readable medium comprising computer-readable instructions for causing a processor to perform the method of claim 1.

12. A method of preventing phishing of personal information, comprising:
receiving a request to establish a connection to a secure socket layer (SSL) website;
determining a validity of the SSL website;
preventing the connection to the SSL website when the SSL website is determined invalid,
wherein determining the validity of the SSL website comprises authenticating a certificate of the SSL website.

13. The method of claim 12, wherein preventing the connection to the SSL website comprises blocking connection to the SSL website.

14. The method of claim 12, wherein preventing the connection to the SSL website comprises preventing rendering of the SSL website.

15. The method of claim 12, wherein the SSL website is determined invalid if the certificate is expired.

16. The method of claim 12, wherein the SSL website is determined invalid if the certificate is revoked.

17. The method of claim 12, wherein the SSL website is determined invalid if the certificate is an incorrect type.

18. The method of claim 12, wherein the SSL website is determined invalid if the certificate does not originate from an issuer that is known and trusted.

19. The method of claim 12, wherein the SSL website is determined invalid if the certificate is self-signed.

20. A system for preventing information theft, comprising:
an input for receiving a request to establish a connection to a secure destination;
a processor configured to determine a validity of the secure destination and prevent the connection to the secure destination when the secure destination is determined invalid, wherein determining the validity of the secure destination comprises authenticating security credentials of the secure destination.
